(19) United States
(12) Patent Application Publication
(10) Pub. No.: US 2017/0064240 A1
(43) Pub. Date: Mar. 2, 2017

(54) PLAYER POSITION AND AUXILIARY INFORMATION VISUALIZATION

(71) Applicant: Microsoft Technology Licensing, LLC, Redmond, WA (US)

(72) Inventors: Preetinderpal Singh Mangat, Surrey (CA); Daniel Daigle, Vancouver (CA); David Ferguson, Vancouver (CA); Guillaume LaHaye, Vancouver (CA); Michael Mahar, Vancouver (CA); David Seymour, Burnaby (CA); Trey Smith, Vancouver (CA); Amardeep Tiwana, Surrey (CA); Simon Warrington, Vancouver (CA)

(73) Assignee: Microsoft Technology Licensing, LLC, Redmond, WA (US)

(21) Appl. No.: 15/099,470

(22) Filed: Apr. 14, 2016

Related U.S. Application Data
(60) Provisional application No. 62/209,300, filed on Aug. 24, 2015.

(51) Int. Cl. H04N 5/445; G06F 17/30

(52) U.S. Cl. CPC H04N 5/445; G06F 17/30268; G06F 17/30867

(57) ABSTRACT

A network-accessible computer comprises a network-communications interface configured to receive player-position data via a computer network. The player-position data indicates a multi-dimensional position for each of a plurality of players participating a sporting event. The network-accessible computer further comprises a logic machine configured to derive auxiliary information from at least the player-position data, the auxiliary information not included in the player-position data and indicating specific attributes for one or more of the plurality of players during a period of game activity in the sporting event. The logic machine packages the auxiliary information with the player-position data into a client-readable data package usable by a client computing device to construct a user interface visualizing at least the player-position data and auxiliary information. The logic machine sends the client-readable data package to the client computing device via the network-communications interface.

### CROSS REFERENCE TO RELATED APPLICATIONS

This application claims priority to U.S. Provisional Patent Application No. 62/209,300, filed Aug. 24, 2015, the entirety of which is hereby incorporated herein by reference.

### BACKGROUND

Sporting events may be viewed in person, on cable television, on over-the-air television, via on-demand video, via an online streaming service, and via other viewing modalities. Viewing of live and time-shifted sporting events is a popular activity in a number of cultures. Many people enjoy reviewing statistics for specific sports teams and sports players.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A network-accessible computer comprises a network-communications interface configured to receive player-position data via a computer network. The player-position data indicates a multi-dimensional position for each of a plurality of players participating in a sporting event. The network-accessible computer further comprises a logic machine configured to derive auxiliary information from at least the player-position data, the auxiliary information not included in the player-position data and indicating specific attributes for one or more of the plurality of players during a period of game activity in the sporting event. The logic machine packages the auxiliary information with the player-position data into a client-readable data package usable by a client computing device to construct a user interface visualizing at least the player-position data and auxiliary information. The logic machine sends the client-readable data package to the client computing device via the network-communications interface.

### BRIEF DESCRIPTION OF THE DRAWINGS

FIG. 1 schematically shows an example entertainment environment

FIG. 2 schematically shows a flow from a sporting event to a client computing device.

FIG. 3 schematically shows transmission of player-position data over a series of time frames.

FIG. 4 shows example method for presenting sporting event information.

FIG. 5 schematically shows an example user interface for visualizing sporting event related data.

FIG. 6 schematically shows an example user interface presenting player-specific information.

FIG. 7 schematically shows an example user interface summarizing a series of periods of sporting event activity.

FIG. 8 schematically shows an example network-accessible computer.

### DETAILED DESCRIPTION

Sporting events are commonly recorded using traditional video cameras which capture footage of the sporting event from a limited number of angles and perspectives. Viewing of the sporting event is then constrained to only the angles and perspectives captured by the cameras. This can make it difficult for viewers and sports officials to determine exact player locations, and accordingly to develop a comprehensive understanding of the movements and actions of each player during a particular period of activity. More advanced player tracking technology, including motion sensors, depth cameras, RFID chips, and other position trackers may be used to more accurately estimate the specific positions and movements is of individual players in a sporting event. From this player-position data, auxiliary information may be derived which indicates specific attributes for individual players. The player-position data and the auxiliary information, as well as any supplemental information received from supplemental information sources, may be used by client computing devices to render detailed representations of sporting event activity, allowing viewers to view and replay specific periods of activity in the sporting event, from any angle, and easily obtain detailed information for any player/team.

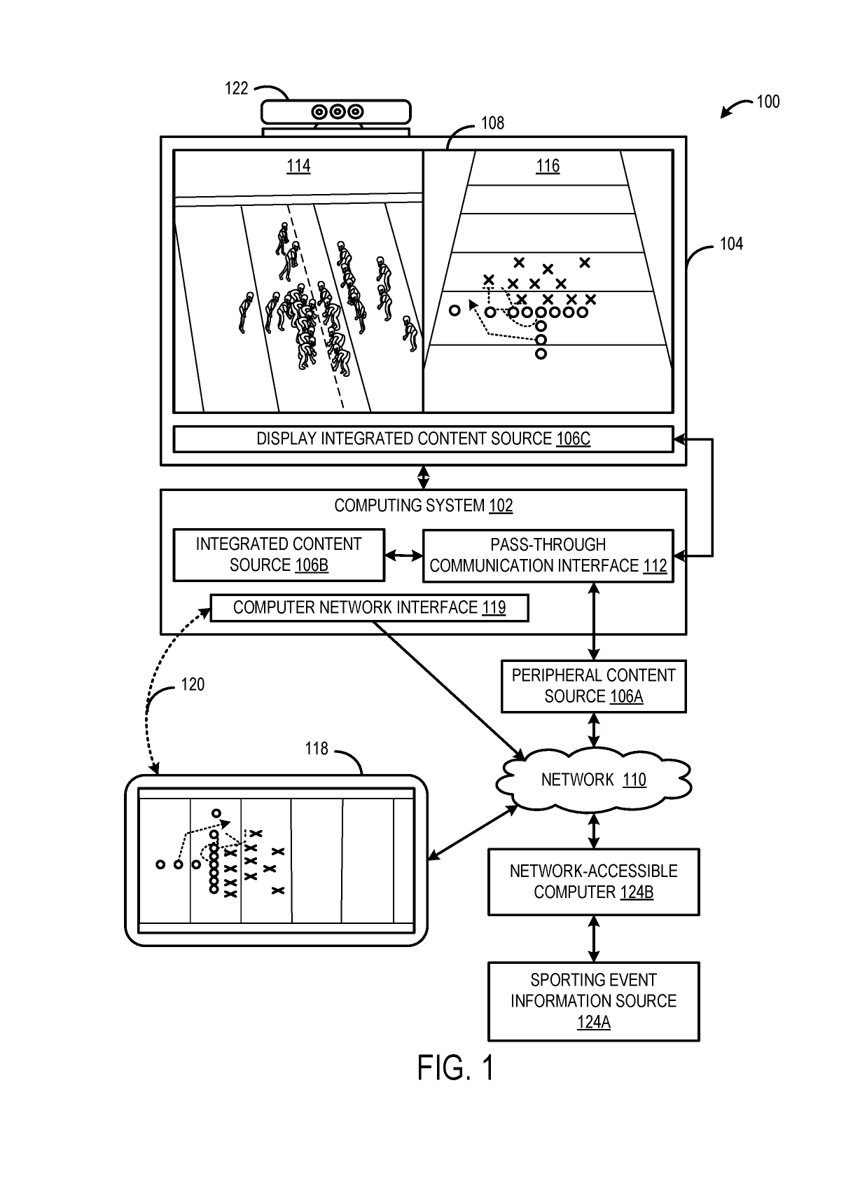

FIG. 1 shows a non-limiting example of an entertainment technology environment 100. In particular, FIG. 1 shows a computing system 102 in the form of an entertainment console that may be used to present enhanced sporting event experiences, a variety of different video games, one or snore different media content items, and/or execute non-game applications and/or operating systems. Computing system 102 is connected to a display 104 such as a television or a computer monitor, which may be configured to present enhanced and/or unenhanced sporting events, media content, game visuals, non-game computing content, and/or other content to users of the display

An entertainment console is just one example of a suitable computing system, and computing system 102 may take any suitable form without departing from the scope of the present disclosure. For example, computing system 102 may instead be a personal desktop computing device, a laptop computing device, a mobile computing device (e.g., tablet computer or smartphone), a smart television, a peripheral device configured to be connected to a display (e.g., a set-top box), a wearable computing device, a virtual or augmented reality head-mounted display device, or another form of computing device.

Computing system 102 may be configured to provide intermediate control of content provided by a plurality of content sources 106 (e.g., 106A and 106B) for visual presentation via display 104. In particular, computing system 102 may provide a unified graphical user interface (GUI) 108 with which a user may interact to select content from various sources and/or to discover and consume other relevant content. In this way, content from various disparate sources may be accessed through a single user interface. Further, computing system 102 may be configured to present, via GUI 108, complementary information about each content item in addition to providing an access point to the content item. Further still, computing system 102 may be configured to associate content. From different sources with an identified content item. For example, computing system 102 may be configured to display such associated content simultaneously with the identified content item in GUI 108 in order to enhance a viewing experience of the identified content item.

In some implementations, the plurality of content sources 106 may include one or more peripheral content sources 106A, such as external devices attached to computing system 102. Examples of peripheral content sources 106A include, but are not limited to, a cable box, a satellite receiver, a digital television receiver, a DVD player, a Blu-ray player, a set-top box, a media center computer, a digital video recorder, or another peripheral device. Peripheral content sources may be connected to computing system 102 in any suitable manner, including but not limited to, HDMI, Component Video, Thunderbolt, USB, Ethernet, WiFi, and Bluetooth.

In some implementations, the plurality of content sources 106 may include one or more integrated content sources 106B that is/are directly integrated into computing system 102. Examples of integrated content sources 106B include, but are not limited to, an optical drive, a local storage device, an over-air tuner, an IP tuner, a satellite tuner, a cable tuner, or another form of television or broadcast signal tuner.

In some implementations that utilize a detached display, the plurality of content sources 106 may include one or more display integrated content sources 1060 that is/are integrated into display 104. Examples of the display integrated content source 106C may include, but are not limited to, an optical drive, a local storage device, over-air tuner, an IP tuner, a satellite tuner, a cable tuner, or another form of television or broadcast signal tuner.

In some implementations, one or more of the plurality of content sources 106, whether peripheral or integrated, may be network content sources that are configured to receive media content via a computer network 110, such as the Internet.

The plurality of content sources 106 may be configured to provide linear and/or non-linear content for visual presentation via display 104. Linear content may include any suitable form of live or time synchronous content, such as live television programming (e.g., a live-action sporting event that is currently taking place). Linear content may also include any suitable form of time-shifted content, such as previously recorded television programming or video on-demand con tent Non-linear content may include data that may be accessed in any order web page data, database data, linked data). The plurality of content sources 106 may provide any suitable content to computing system 102 and/or display 104 without departing from the scope of the present disclosure. Moreover, the plurality of content sources 106 may provide any suitable number of different content feeds/video streams to computing system 102 and/or display 104 without departing from the scope of the present disclosure. For example, computing system 102 may receive a plurality of different feeds/video streams of different live-action sporting events, and computing system 102 may be configured to intelligently select which live-action sporting event to visually preset vii display 104. In another example, computing system 102 may receive a plurality of different feeds of the same live-action sporting event (e.g., different camera angles), and computing system 102 may be configured to intelligently select which feed of the live-action sporting event to visually present via display 104.

Computing system 102 may include video and/or audio signal pass-through functionality (e.g., HDMI pass-through) via a pass-through communication interface 112. In particular, pass-through communication interface 112 may be configured to allow a video and/or audio signal sent from a content source 106 to be directed through computing system 102 to display 104 and/or other audio/visual equipment. For example, a broadcast television signal or other audio/video/data signal received at a television tuner (e.g., integrated into display 104 and/or integrated into a set top box or other content source) and/or other content source may be sent to the computing system 102 via an internal bus, an external cable (e.g., an HDMI cable, coaxial cable, and/or other data cable), and/or a wireless connection. The signal may then pass through computing system 102 to a display device (e.g., display 104) and/or audio device to present content to a user. Such pass-through functionality allows computing system 102 to control transmission of the signal to display 104. In some examples, computing system 102 may pass the signal to the display with minimal or no adjustment of the signal (e.g., passing the raw signal and/or selectively processing the raw signal only to conform to playback constraints of the display). In other examples computing system 102 may selectively present information from the signal alongside additional information and/or otherwise add, subtract, and/or adjust the displayed information via pass-through communication interface 112 and/or other processors within computing system 102. Pass-through communication interface 112 may enable additional functionality, such as overlaying GUI 108 with video from the existing video signal and other functionality described in further detail herein.

Computing system 102 (e.g., an operating system, application, program, and/or other software executed by a processor of the computing system in some examples) may recognize the user's cable/satellite/broadcast listings from the user's cable/satellite/broadcast headend data as received via the pass-through communication interface 112. The computing system may additionally or alternatively recognize the listings and/or a currently-viewed program via audio/video signature analysis. Computing system 102 may run a query against the cable/satellite/broadcast service provider to find all programming matching application content (e.g., all football programming for a fantasy football application) that would be available to the user.

Rendering the broadcast directly in an application allows the application to use the results from the query to surface/provide to the user all or a selected subset of relevant programming and to monitor for events of interest to the user on the relevant programming. By recognizing the user's cable./satellite/broadcast listing via the pass-through signal, an analysis of the displayed content, and/or user input specifying cable/satellite broadcast provider, the application may identify the channel number of the viewed original program and/or a secondary program (e.g., a program that triggers a notification of an event of interest to the user). The identification of the channel may additionally allow a user to network into and/or otherwise connect to the application running on the computing system 102 (e.g., via a secondary device) so that the user may be presented the broadcast content via the display device responsive to a suitable user input (e.g., a click of a button on a secondary device, to auto change channel for example) or to manually tune the pass-through broadcast content. In this way, a user may use a remote device (e.g, a smartphone, controller, and/or other suitable input device) to provide input to the computing system 102 to instruct the computing system to tune to a selected channel of broadcast data from a content source and display that selected channel in the application via the display device. Further, the user may continue watching the video content and continue using the application without authenticating, subscribing, or signing up to the video content outside of the primary device, and may watch the same content (e.g., live sports games)) through the broadcast.

Computing system 102 may include a shell configured to provide GUI 108 that allows users to access (e.g., via voice commands, gesture commands, remote control input, or other input) various operating system (OS) services and applications executed by computing system 102. GUI 108 may be visually organized in any suitable manner without departing from the scope of the present disclosure. For example, GUI 108 may present various destinations or pages in the shell. Such destinations or pages may include different applications and/or content items provided by different sources. For example, content items may include sporting events, movies, TV programs, games, music, and other forms of digital media. In one example, GUI 108 may include a home page providing access to applications, digital content, and other shell destinations. In some cases, the home page may be curated based on preferences, behavior, and previous interactions of a user (or a group of users, e.g., a family).

Computing system 102 may be configured to support execution of a plurality of different applications. For example, GUI 108 may provide support for a diverse ecosystem of applications provided by using system 102 and/or third-parties. For example, GUI 108 may include a shell destination in the form of an application store or portal for acquiring various applications and/or digital content. Further, acquired (e.g., downloaded) applications may be organized at various shell destinations and/or located or “pinned” on the home page.

Computing system 102 may be configured to support multi-tasking between different applications as well as background services. In one example, computing system 102 may be configured to support switching quickly between different applications that occupy the full screen of GUI 108. In another example, computing system 102 may be configured to display two or more applications simultaneously in a split-screen “snap” mode of GUI 108. In yet another example, computing system 102 may be configured to run services or other tasks in the background while using different applications in the foreground. In some implementations, such applications and background services may correspond to different contextual states of computing system 102. In some implementations, a full screen or snap application may be augmented with graphic and/or sound overlays provided by the operating system and/or another application.

In the illustrated example, GUI 108 is operating in the snap mode in which a television broadcast of a football game 114 (e.g., provided via pass-through communication interface 112 from content source 106) and a companion application 116 providing football statistics of players playing in football game 114 are visually presented simultaneously via display 104. Alternately, GUI 108 may present either football game 114 or companion application 116 in full-screen mode. Further, companion application 116 may render football game 114 in one or more application windows, as well as enhance the rendered football game with information generated by the computing system and/or received from remote service computing systems.

In some implementations, computing system 102 may be in communication with an auxiliary computing device 118 (e.g., tablet computing device or smartphone) via a computer network interface 119. In one example, computing system 102 may communicate with auxiliary computing device 118 via network 110. In another example, computing system 102 may communicate with auxiliary computing device 118 via a direct communication link 120, such as a radio (e.g., Bluetooth) link. Auxiliary computing device 118 may be configured to present content associated with a content item controlled by computing system 102 and/or visually presented via display 104. In one example, the television broadcast of the football game 114 may be visually presented via display 104 in a full-screen view, and the companion application 116 may be visually presented via the auxiliary computing device 118, or vice versa. The auxiliary computing device 118 may be configured to present any main or auxiliary viewing experience or a portion thereof alone or in cooperation with computing system 102 and/or display 104. Moreover, computing system 102 may be configured to communicate with any suitable number of auxiliary computing devices and/or displays to provide any suitable number of different content items and/or content consumption experiences.

In some implementations, computing system 102 may be in communication with a capture device 122 that audibly and/or visually tracks objects within an observed scene (e.g., the living room where display 104 is located). Capture device 122 may be operatively connected to computing system 102 via one or more wired or wireless interfaces. In one nonlimiting example, capture device 122 may include an infrared light source to project infrared light onto the physical space and a depth camera configured to receive reflected infrared light. The capture device also may comprise other sensors, including but not limited to two-dimensional image sensor(s) (e.g., a visible light camera such as an RGB image sensor and/or a grayscale sensor) and one or more microphones (e.g., a directional microphone array).

Computing system 102 may be configured to identify each user in entertainment technology environment 100 based on audio and/or video data received from capture device 122. For example, facial recognition, voiceprint identification, anatomical measurements (e.g., derived from depth map information), and/or other suitable techniques may be used to determine a biometric identity of a user in the entertainment technology environment. In one particular example, voice input directionally identified with a beam forming microphone array may be correlated with any biometric identification discerned using standard and/or depth video to identify a user. It will be understood that user identification can be accomplished in any suitable manner. Furthermore, once a user has been identified, that user may be tracked (e.g., viewing display, providing gesture-based input, providing voice input, providing control device input, and other suitable interactions), via capture device 122. Such tracking may be associated with the user's identity.

The above described features of capture device 122 may be leveraged by computing system 102 to provide various functions to users. For example, information from capture device 122 may be used by computing system 102 to provide video and/or voice chat capabilities with remote users. In one example, capture device 122 may capture video and audio data of a user interacting with entertainment technology environment 100. Further, computing system 102 may send captured video and audio data to another remotely-located user computer as part of a video chat session some implementations, such video chat functionality may be incorporated into an application that may be executed simultaneously with other applications by computing system 102.

In some implementations, computing system 102 may be configured to communicate, via computer network interface 119, with a plurality of remote network-accessible computers 124 (e.g., 124A, 124B) connected to network 110. For example, the plurality of remote network-accessible computers 124 may be configured to provide complementary information, perform data analysis/processing, and/or perform other operations related to controlling or enhancing presentation of a content item.

In the illustrated example, a sporting-event information source 124A may be a network-accessible computer including information pertaining to a sporting event or other content item. Sporting-event information source 124A may provide complementary information about one or more sporting events and/or other content items. Continuing with the example of the football game, the sporting event information source 124A may provide player-position data and/or other play-by-play information as the football game occurs. In one example, sporting event information source 124A is a football game reporting computing system operated or associated with the National Football League (NFL) to provide game data to requesting computers via various APIs. In this example, the complementary information may take the form of player-position data, received from various position trackers and indicating the current positions of one or more game players/officials/objects.

A network-accessible computer 124B may receive the content item information from sporting event information source 124A. Network-accessible computer 124B may be configured to perform processing, analysis, or other operations on the content item information to generate supplemental content or other information that may be sent to computing system 102 to enhance a viewing experience of the content item. Continuing with the example of the football game, network-accessible computer 124B may perform analysis on game data (e.g., player-position data) to prepare a client-readable data package, usable by computing system 102 and/or auxiliary computing device 118 to construct a user interface visualizing information included in the client-readable data package. Such information may include player-position data, auxiliary information, and/or other supplemental information for a particular content item, such as a live football game. Network-accessible computer 124B may be configured to send the client-readable data package to computing device 102 for near real time visualization of player-position data and/or auxiliary information via companion application 116 (e.g., a sports scores application). In another example, network-accessible computer 124B may provide a fantasy-style statistical game that a user may participate in while viewing the football game.

In some implementations, information pertaining to real-world sporting events, such as player-position data of a football game, may be obtained through the use of a plurality of cameras, sensors, and/or other position trackers. Such position trackers may take the form of motion sensors embedded in a gameplay field/court/arena/area, and/or cameras (including 3D depth cameras, stereoscopic cameras, infrared cameras, etc.) mounted in and around the gameplay area and configured to monitor gameplay events. Additionally, position trackers (including, for example, RFID chips) may be worn by/embedded on real-world game players/coaches/officials, game balls and/or other objects, game landmarks, etc., and each may include a unique identifier, signature, and/or other mechanism for specifying the unique entity with which the position tracker is associated. Position trackers may further comprise biometric sensors worn by each real-world game player/coach/official, and configured to measure one or more biometric parameters, including heart rate, respiration rate, blood pressure, metabolic rate, kilocalories burned, as well as any other suitable biometric information. Virtually any type of position tracker may be used, and such position trackers may be configured to obtain virtually any information pertaining to a real-world sporting event.

Player-position data collected from these position trackers may be subjected to one or more processing/analysis steps in order to generate a variety of useful information pertaining to the real-world sporting event. Such processing/analysis may be performed by network-accessible computers including sporting event information source 124A and/or network-accessible computer 124B prior to the information being sent to computing system 102 and/or auxiliary computing system 118. For example, player-position data from the position trackers may be usable to determine which real-world players/coaches/officials are currently in the sporting event, as well as their positions relative to each other, to any game balls or other important objects, and/or to any gameplay landmarks. Accordingly a network-accessible computer, such as sporting event information source 124A and/or network-accessible computer 124B may be usable to derive a variety of auxiliary information from the player-position data. The auxiliary information may indicate, for example, which players are currently participating in the game (e.g., on the field/court/play area), how fast each player/game ball is moving, which player is in possession of a game ball, a length of time a particular player is in possession of a game ball, a distance travelled by a player and/or game ball during a period of time, etc. Further, the network-accessible computer may package the player-position data, auxiliary information, and/or other supplemental information into a client-readable data package, and send the data package to one or more client computing devices, such as computing system 102 and auxiliary computing system 118.

Such information may be presented by GUI 108 via an application program interface (API), as part of a dedicated data stream, and/or as metadata from a content stream. As such, the information presented by GUI 108 may be based at least in part on the information collected by the position trackers. Further, such data may be collected, uploaded, and accessed substantially in real time. For example, GUI 108 may present information retrieved from a content source 106 via an API as the information updates, allowing the information presented by GUI 108 to update at substantially the same time real-world events unfold (allowing for necessary processing and/or transmission time). In some implementations, one or both of the sporting event and the supplemental information may be time-shifted relative to the other so that the sporting event and the supplemental information are time synchronized with one another at playback.

In some implementations, network-accessible computer 124B and computing system 102 may be affiliated with a same platform or computing ecosystem. In some such implementations, network-accessible computer 124B may be configured to provide the complementary information to any computing system that is affiliated with that platform or computing ecosystem. For example, the network-accessible computer 124B may include a content distribution network through which client-readable data packages may be distributed to the various computing systems within the computing ecosystem. Other network-accessible computers 124B may be used to provide complementary information to other computing ecosystems. In some implementations, the same network-accessible computer 124B may provide information to different computing ecosystems, for example via an ecosystem agnostic API or multiple ecosystem specific APIs.

In some implementations, sporting event information source 124A may send the content item information directly to computing system 102 without any intervention from network-accessible computer 124B

The above described features of computing system 102 may be leveraged to provide functionality related to controlling presentation of media content. More particularly, computing system 102 may provide functionality related to enhancing presentation of media content beyond what is provided by a content source.

In some implementations, computing system 102 may be configured to enhance presentation of a live-action sporting event by constructing a user interface visualizing information included in a client-readable data package received from a network-accessible computer. Such a user interface may be configured to visually present real-time position and/or statistical data and/or predictions of upcoming events that occur during the live-action sporting event. For example, position and/or statistical data and/or predictions of aspects of a live-action sporting event may be included in an overlay that is visually presented simultaneously with a broadcast feed/video stream of the live-action sporting event. In another example, statistical data and/or predictions may be provided by a companion application that is visually presented simultaneously (e.g., side-by-side, picture-in-picture) with a broadcast feed/video stream of the live-action sporting event. In some implementations, the statistical data and/or predictions can be presented with time-shifted content, thus allowing a viewer to simulate a live viewing experience after a sporting event has already taken place. In some implementations, the statistical data and predictions can be presented without video footage of the underlying sporting event. In any case, computing system 102 may generate and/or relay the user interface constructed from the client-readable data package separate from the video stream received by computing system 102 from a content source 106.

In some implementations, different computing systems may enhance the same live-action sporting event differently for different users by visually presenting different information included in the client-readable data package based on a different state or condition of the computing system and/or different criteria/preferences of one or more users associated with the computing system.

These and other concepts are described herein using an example scenario of viewing a football game. However, such concepts may be broadly applicable to any suitable live event, sporting or otherwise.

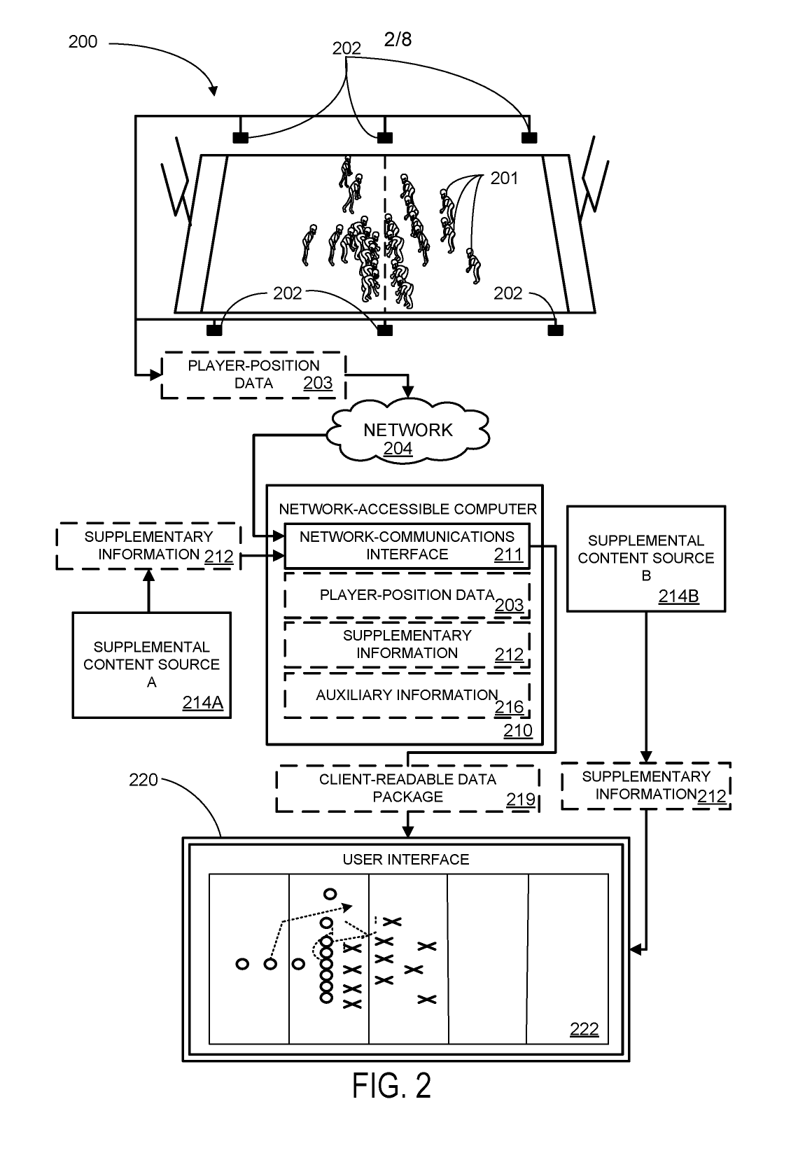

FIG. 2 schematically shows flow of sporting event-related data from a live sporting event 200 to a client computing device 220. In general, client computing device 220 may be any device usable for receiving and interpreting sporting event-related data. Each of computing system 102 and auxiliary computing system 118 may be an example of a client computing device.

Sporting event 200 includes a plurality of players 201, each player having a different multi-dimensional position with respect to each other player and the gameplay area. In the case of an American Football game, the multi-dimensional position may include an x coordinate and a y coordinate that collectively define a player's position on the football field. Each player's multi-dimensional position may be tracked by one or more position trackers 202. As described above, one nonlimiting example, each player 201 may be associated with one or more unique RFID chips, embedded in one or more parts of the player's uniform. Position trackers 202 may comprise receivers capable of detecting and localizing signals emitted by the RFID chips. Accordingly, the position trackers 202 may generate player-position data 203 indicating a multi-dimensional position for each of the plurality of players participating in the sporting event. At any given moment, the sporting event may include one or more players not actively participating (i.e., “on the bench”). Accordingly, player-position data may be generated for all players affiliated with the sporting event, or only those actively participating at a given moment in time. Player position data may be collected by one or more computing systems, such as sporting event information source 124A, and made available to one or more network-accessible computers as will be described below.

From sporting event 200, player-position data 203 may be sent to a network 204 which may take the form of a computer network such as, for example, the Internet. Player-position data may be sent as a stream of discrete data packets identifying player positions for one or more moments in time, or time frames. Each time frame may be marked with a time code, allowing specific events (e.g., play start, play stop) to be correlated with specific time frames. Each data packet may include data for one or more different time frames. The data stream may have a particular frequency describing the temporal separation between subsequent data packets. In some examples, this frequency may be equal to 10 Hz.

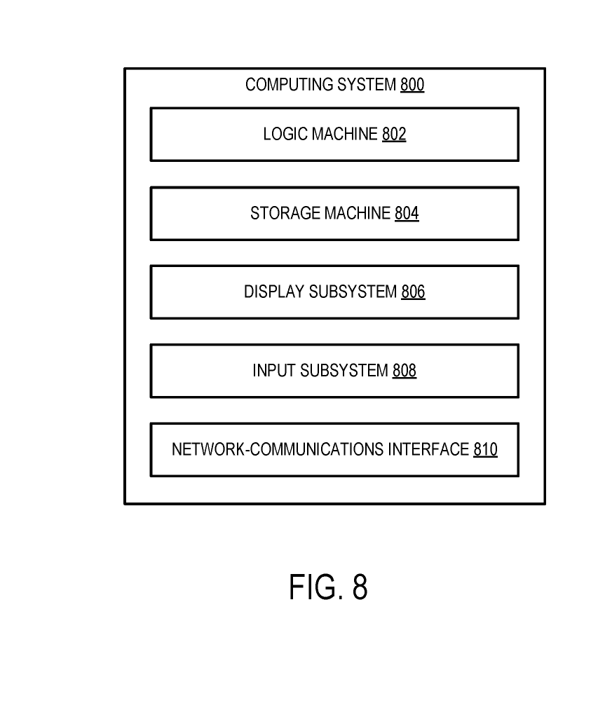

In the illustrated example, a network-accessible computer 210 receives the player-position data from the computer network via a network-communications interface 211 of the network-accessible computer (e.g., wifi radio or Ethernet port). Network-accessible computer 210 may be an example of the network-accessible computer 124B shown in FIG. 1, for example. Network-accessible computer 210 may be implemented as one or more server computers and/or other suitable combination of hardware components, and may include one or more processors/logic machines for processing and analysis of data, as will be described in further detail below with respect to FIG. 8.

Upon receiving the player-position data, the network-accessible computer may be configured to verify the player-position data. Verification may be done according to a number of criteria. For example, verification may include determining that the player-position data is received for an expected number of players. In the case of a football game, this may be equal to 22 players. Additional criteria may include determining that a set of player-position data corresponding to a particular period of game activity includes all required events. For example, a set of player-position data corresponding to a football play may be required to include at least a ball snap event and a play-stop event. If the player-position data does not meet one or more verification criteria, it may be subject to additional processing for data cleaning/repair, and/or discarded.

Similarly to the player-position data, the network-communications interface of the network-accessible computer 210 may be configured to receive supplemental information 212 pertaining to the sporting event from one or more supplemental content sources 214. Two supplemental content sources 214 are schematically illustrated in FIG. 2. In general, a supplemental content source may be any service, database, and/or other information source capable of providing information/media relevant to the sporting event. For example, a supplemental content source may be owned/maintained by an organization facilitating the sporting event, and include detailed player rosters, statistics, replay videos, fantasy sports games, etc. Additionally,a supplemental content source may be provided by a 3^{rd} party, and provide player statistics, game analysis, reactions to the sporting event (e.g., via a social network), etc. A supplemental content source may additionally be maintained by a television network or other content distribution organization. Such a content source may obtain raw video footage of the sporting event and make it viewable to one or more viewers (e.g., via broadcast/cable television and/or an online streaming website). As pictured, supplemental content source 214A sends supplemental information to client computing device 220 via network-accessible computer 210, while supplemental content source 214B sends supplemental information directly to client computing device 220.

Upon receiving the player-position data 203 and any relevant supplemental information 212, the network-accessible computer may derive auxiliary information 216 from at least the player-position data. In some examples, auxiliary information may be derived solely from the player-position data. Alternately, auxiliary information may be derived from a combination of player-position data 203 and received supplemental information 212. Auxiliary information 216 may indicate specific attributes for one or more of the plurality of players 201 during a period of game activity. In general, auxiliary information 216 may include virtually any sporting event-related information not included in the raw player-position data.

The auxiliary information may associate specific identities (e.g., player name, player number) with individual players participating in the sporting event. For example, supplemental information may include a player roster and/or player statistics for a recently completed play. Deriving auxiliary information may therefore include correlating the received supplemental information with known player movements based on the received player-position data, thereby determining the identities of each player represented in the player-position data. Such identities may additionally include an indication of what position each player is currently playing quarterback, tight-end, receiver).

Auxiliary information may include 3-dimensional virtual models of each real-world player/coach/official, as well as each game ball/important game object and/or game landmark. For example, precise positional data may be obtained for each player through the use of a variety of position trackers. Each player's precise position may be tracked through a plurality of RFID chips worn by the player, and these chips may be positioned such that the positions of various parts of the player's body are tracked independently. Further, data from the RFID chips may be combined with information from one or more cameras and/or other information trackers in order to obtain precise positional/postural information for each player. Further, such information optionally may be used to generate 3-dimensional models, which may comprise “skeletal” models, including information pertain the relative positions, orientations, and movements of the player's various limbs/appendages. Such skeletal models may lie used to render three-dimensional player avatars that mimic the real world movements of a modeled player. Such avatars may be subjected to additional processing/analysis steps, and/or may be presented to one or more users via a virtual interactive interface, as described in further detail below.

Player-position data may be used to determine auxiliary information in the form of a number of player-specific statistics for one or more of the plurality of players. Such auxiliary information may include at least a top speed for each of the one or more players. The auxiliary information may additionally indicate an average speed for each player, a highest top speed of all players, a total distance traveled for each player, each player's average/maximum horsepower, each player's maximum/average kinetic energy, as well as any other calculable statistics which sporting event viewers may find useful/informative. Because such auxiliary information may not be included in the received player-position data, the auxiliary information may be derived from the player-position data and supplemental information. For example, a top speed may be found by finding maximum of a first derivative of a player's position, as represented by the player position data. In some implementations, the data may be filtered to remove abnormalities in the data. As another example, a total distance traveled may be calculated by summing the frame-to-frame position deltas for a desired duration.

In some examples, player-position data may not indicate which of the participating players had possession of a game ball during a period of game activity. Accordingly, deriving auxiliary information may include identifying one or more of the plurality of players had possession of the game ball (e.g., which player(s) had possession of the football during a recently completed play) described above, supplemental information may include a list of game statistics for a period of game activity. Such statistics may indicate, for example, that a particular player carried a football eight yards for a first down. In light of this information, the network-accessible computer may analyze the player-position data in order to identify as the ball carrier the player described by the supplemental information. Similarly, the game statistics may indicate that a quarterback successfully passed a football to a receiver, who carried the ball into the end zone for a touchdown. The network-accessible computer may then identify the ball carrier by determining which players in the player-position data correspond to the players described by the game statistics. Once the ball carrier has been identified, additional derived auxiliary information may include a top speed attained by a ball carrier, a total distance traveled by a ball carrier, a total length of time a player was in possession of the ball, etc. Further, the auxiliary information may indicate an initial position and a final position of the game ball during a period of game activity relative to at least one dimension. For example, in a football game, auxiliary information may indicate the one-dimensional position of the ball at the beginning of a play relative to the football field's yard lines (i.e., the line of scrimmage), as well as the position of the ball at the end of the play. Alternately, the auxiliary information may indicate multi-dimensional initial and final positions of the ball. This may additionally be based at least in part on received supplemental information, as described above.

Deriving the auxiliary information may also include identifying any issues with the received player-position data. For example, data may be received which is incomplete or has duplicate entries, or include anomalies such as missing time segments or indications that a player moved at an unrealistic speed. Identified issues may be remediated and/or the affected player-position data may be discarded.

As described above, the auxiliary information may include specific attributes for one or more of the plurality of players. Based on numerical values of these attributes (e.g., top speed, distance covered, distance covered while in possession of a game ball), players may be compared to one another, compared to players on other sporting teams, historical players, etc. Further, the auxiliary information may identify one or more notable players having a highest ranking with respect to one or more attributes. Specific identities and/or labels may be applied to each identified player. Examples of labels which may be applied in a football game include 1) Afterburner—a player who achieved the highest overall speed while in possession of the football; 2) Scrambler—a quarterback who traveled a furthest total distance before completing a positive yard pass; 3) Return Artist—A ball carrier who traveled a highest total distance during a kick-off or punt return; 4) Workhorse—A player with a greatest difference between positive yards gained and total distance covered; 5) Catalyst—a ball carrier who achieved a highest overall speed while crossing a line of scrimmage; 6) Juggernaut—A ball carrier who achieved a highest top speed during a play beginning in a red zone and resulting in a touchdown; and 7) Unbreakable—A ball carrier who traveled a highest total distance during a play beginning in a red zone and resulting in a touchdown. In some examples, notable players may be represented by a user interface differently from other players of the plurality, as will be described in more detail below.

Notable players as described above may be tracked in one or more user-viewable leaderboards. These leaderboards may track notable players for each individual team in a sports league, as well as for the sports league as a whole. Further, notable players may be tracked over different intervals of time. For example, one leaderboard may list notable players for a particular game, while other leaderboards list notable players for a week, a season, a decade, etc. Leaderboards may be generated by network-accessible computers and/or client computing devices in possession of auxiliary information, and/or stored by one or more supplemental content sources and accessed as desired.

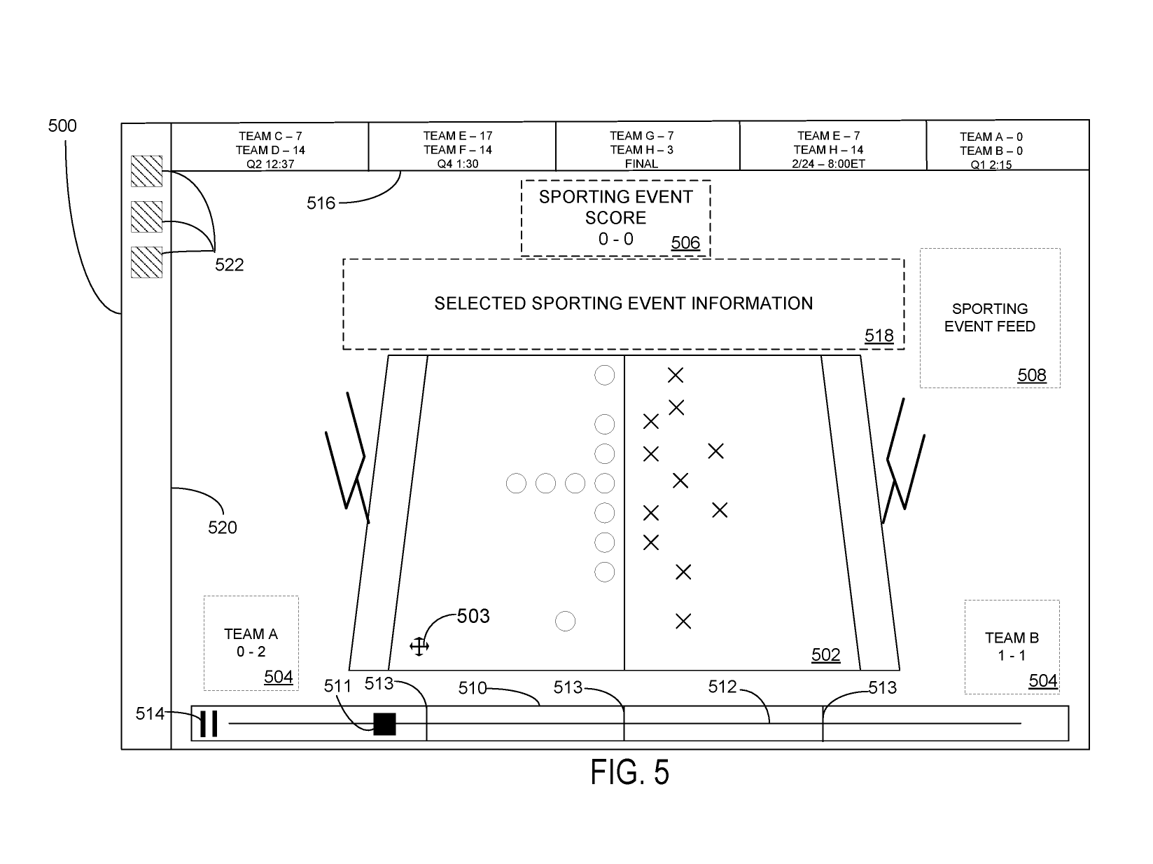

After receiving player-position data 203, any relevant supplemental information 212, and deriving auxiliary information 216, network-accessible computer 210 may package player-position data 203, auxiliary information 216, and any available supplemental information 212 into a client-readable data package 219. The network-accessible computer may then send the client-readable data package to client computing device 220 via network-communications interface 211. This may facilitate near real time visualization of at least the player-position data and auxiliary information. Alternately, the client-readable data package may be stored by the network-accessible computer and/or other network-accessible data storage systems and accessed by the client computing device as desired. The client-readable data package may be usable by the client computing device to construct a user interface 222 visualizing at least the player-position data and the auxiliary information. Such a user interface may take any suitable form. Examples of user interfaces which may be constructed by a client computing device are given below with respect to FIGS. 5, 6, and 7. As used herein, a user interface visualizing at least the player-position data and the auxiliary information is inclusive of a user interface that visualizes different subsets of the player-position data and/or the auxiliary information at different times. Some of the player-position data and/or auxiliary information may never be visualized at the client computing device.

Though player-position data, auxiliary information, and supplemental information are all described above, these three data types may not always be necessary or present. For example, some implementations may not utilize supplemental information at all, or only include supplemental information in some client-readable data packages. Further, in some implementations, the network-accessible computer may pass the player-position data along to the client computing device without performing an auxiliary information derivation step. The client computing device may then derive the auxiliary information based on the player-position data, or construct a user interface based solely on the player-position data. Additionally, the client-computing device may receive sporting event-related information from sources other than the network-accessible computer described above. For example, as shown in FIG. 2, client computing device 220 receives at least some supplemental information from supplemental content source 214B, independently of network-accessible computer 210. Such supplemental information may be used in addition to/in lieu of data included in client-readable data package 219.

As described above, player-position data may be sent to the network-accessible computer as individual data packets comprising a data stream. Furthermore individual client-readable data packages including player-position data may be sent to the client-computing device as individual data packets comprising a data stream. In some examples, a stream of client-readable data packages may be downsampled relative to the raw stream of player-position data. This may include reducing a frequency of the incoming data stream, and/or discarding client-readable data packages corresponding to less important time frames. Such time frames may include those which occur before/after a notable period of game activity. Further, time frames during a period of game activity corresponding to certain key e is (e.g., the start/end of a play, a player catches a game ball, a player achieves a top speed, scoring events), may be preserved, while other time frames are discarded.

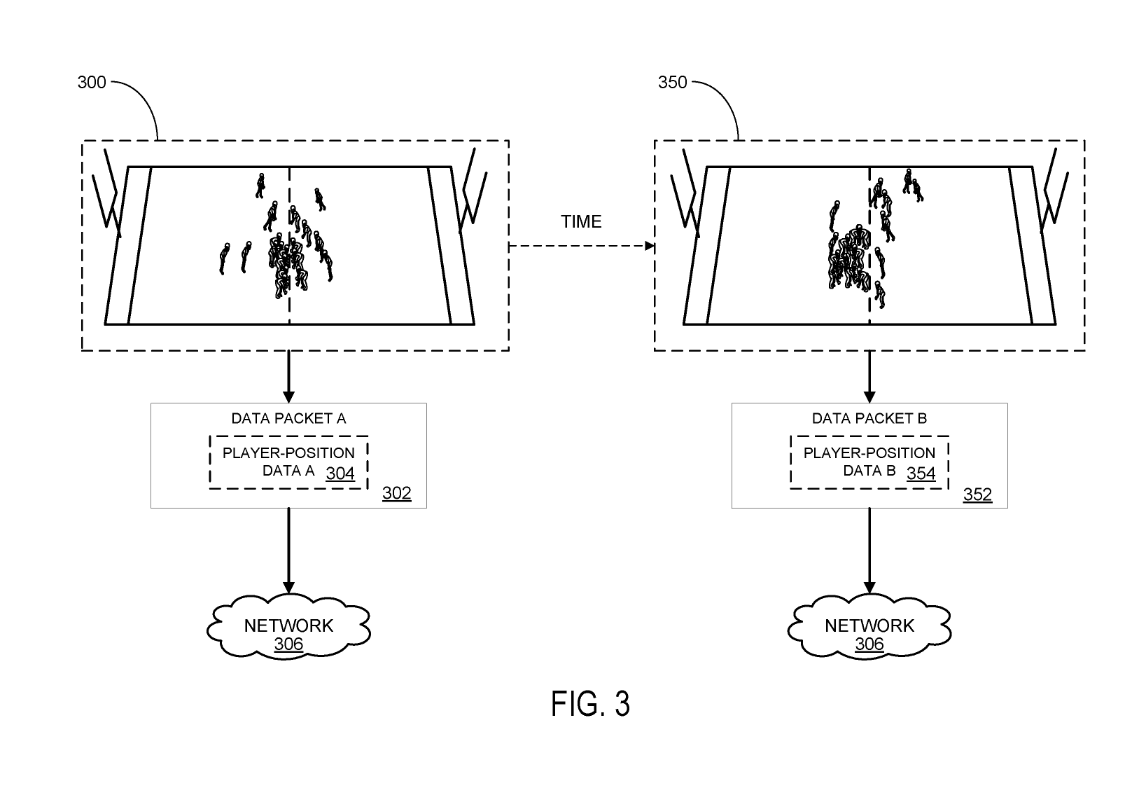

FIG. 3 schematically shows a football game over two different time frames, time frame 300 and time frame 350. As evidenced by the change in player positions between the two time frames, some length of time has passed between time frame 300 and time frame 350. Time frames 300 and 350 may not be immediately-sequential; player-position data may be generated for one or more intermediate time frames that are not shown in FIG. 3.

For each time frame 300 and 350, a data packet is generated including player position data. As shown, player-position data 304 for time frame 300 is included in data packet 304, while player-position data 354 for time frame 350 is included in data packet 352. Because player positions have changed between time frames 300 and 350, player-position data 304 will differ from player-position data 354 to account for the differing player positions. Each of data packets 302 and 352 are sent to network 306, which may be a computer network such as, for example, the Internet. As described above with respect to FIG. 2, player-position data may ultimately be passed along to a client computing device and used to construct a user interface. As shown in FIG. 3, a different data packet, including updated player-position data, may be generated for a series of time frames of a sporting event. This may occur throughout the duration of the sporting event regardless of player activity, or may only occur during periods of active play. As described above, a series of data packets may be received as a data stream having a particular frequency, and this frequency may be adjusted depending upon the needs of a client computing device. Further, each of data packet A and data packet B may include player-position data for one or more time frames other than time frames 300 and 350.

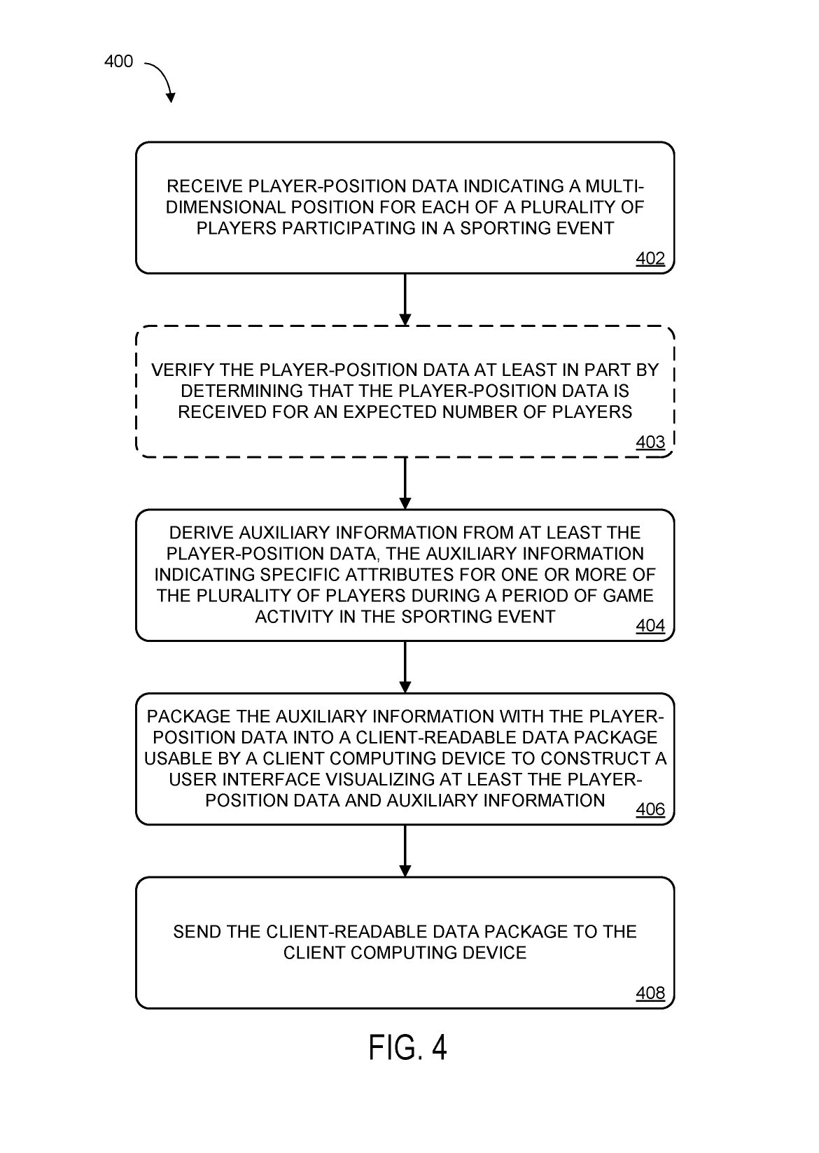

FIG. 4 shows an example method 400 for presenting sporting event information. At 402, method 400 includes receiving player-position data indicating a multi-dimensional position for each of a plurality of players participating in a sporting event. The player-position data may be obtained by a plurality of position trackers configured to track positions of players participating in a sporting event substantially in real-time. Such player-position data may be received by a network-accessible computer as a stream of data packets, each data packet corresponding to one or more different time frames of a period of game activity.

At 403, method 400 optionally includes verifying the player-position data at least in part by determining that the player-position data is received for an expected number of players. In the case of a football game, this may include determining that player-position data is received for 22 actively participating players.

At 404, method 400 includes deriving auxiliary information from at least the player-position data, the auxiliary information indicating specific attributes for one or more of the plurality of players during a period of game activity in the sporting event. Players may be ranked according to their specific attributes/other player-specific statistics, and the auxiliary information may be used to identify one or more notable players.

At 406, method 400 includes packaging the auxiliary information with the player-position data into a client readable data package usable by a client computing device to construct a user interface visualizing at least the player-position data and auxiliary information. Such a user interface may include a representation of one or more players participating in the sporting event, and allow one or more viewers of a sporting event to replay specific periods of game activity, and easily view specific information pertaining to individual players/teams.

At 408, method 400 includes sending the client-readable data package to the client computing device. The client computing device may take any suitable form, such as a game console, smartphone, tablet, laptop computer, desktop computer, media player, cable box, etc. Computing system 102 and auxiliary computing system 118 are examples of client computing devices which may be configured to receive and interpret client-readable data packages.

FIG. 5 shows a user interface 500, which allows one or more users to virtually interact with information pertaining to a selected sporting event. In some embodiments,interface 500 may be presented via a graphical user interface (GUI) such as GUI 108, as one or more applications, operating systems, and/or other sets of computer instructions. Interface 500 may be constructed by a client computer device from a client-readable data package, and visualize one or more of player-position data, auxiliary information, and supplemental information, as described above. Users may choose one or more selected sporting events for presentation by interface 500 from a plurality of available sporting events, which may be already finished sporting events, sporting events which are currently taking place, and/or sporting events which have yet to begin. Interface 500 may present a variety of information about the currently selected sporting event to the users, as will be explained in further detail below. Interface 500 may obtain this information from any suitable source, including content sources 106 described above with respect to FIG. 1, as well as network-accessible computers and/or supplemental content sources as described above with respect to FIG. 2. Data can be delivered from one or more content sources 106 to a computing device such for example, computing system 102 and/or auxiliary computing system 118, that is presenting interface 500 via an application program interface (API), as part of a dedicated data stream, and/or as metadata from a content stream.

Once rendered, interface 500 may be displayed in any appropriate manner. For example, a hardware device may display a rendered interface on an incorporated display, and/or one or more remote displays communicatively linked to the rendering device via a wired and/or wireless connection such as, for example, display 104.

In some embodiments, one or more users may be able to interact with one or more elements of interface 500 and/or hardware devices associated with interface 500 via one or more input devices. Such devices may include touch screens, game controllers, remote controls, mouse/keyboard combinations, natural user-interfaces, and/or holographic/virtual interfaces, among others. Results of user interaction may include altering the information displayed by interface 500, changing the selected sporting event, switching to a different menu/screen within interface 500, changing a playback position and/or volume of any audio content, changing the playback position and/or resolution of any video content, switching a hardware device to display a different active application, as well as affecting virtually any other properties of interface 500 and/or associated hardware devices.

Interface 500 includes gameplay area 502—a virtual representation of the area in which a currently selected sporting event is played. In FIG. 5, the currently selected sporting event is an American football game. As such, gameplay area 502 is a virtual representation of a football field. However, the selected sporting event could be virtually any type of sporting event, such as basketball, baseball, hockey, tennis, golf, rugby, and soccer, among others, and the type of gameplay area 502 displayed can be configured to match the type of sporting event selected.

Gameplay area 502 indicates the position of all players involved in the sporting event at a specific time (e.g., a current time, an automatically-selected past time, or a user-selected past time). Players shown in FIG. 5 are represented by “O”'s for offensive players, and “X”'s for defensive players. However, individual players can be represented in gameplay area 502 by any number of suitable indicators. Examples of suitable indicators may include player numbers, names, initials, faces, helmets, virtual avatars (two-dimensional or three-dimensional), etc. Gameplay area 502 additionally may indicate the positions of notable gameplay landmarks. For example, as shown in FIG. 5, gameplay area 502 includes a line of scrimmage, end zones, and goal posts. Gameplay area 502 may include virtually any type of gameplay landmark, including landmarks specific to sporting events other than football. For example, if the selected sporting event is a baseball game, gameplay area 502 can indicate the positions of bases and foul lines, among other potential baseball specific gameplay landmarks. Sporting event information used to render gameplay area 502 may be based at least in part on the player-position data and auxiliary information described above.

Further, gameplay area 502 may include one or more camera controls 503, usable for changing the current view and/or display of the gameplay area. For example, a user may pan and/or rotate gameplay area 502 in order to view the sporting event from one or the other team's perspective, view the sporting event from an individual player's perspective, view the sporting event from a “bird's-eye view,” and/or zoom in/out in order to focus on smaller/larger portions of the gameplay area, allowing the user to view gameplay events from any desired angle/viewpoint, as the event occurs. In some embodiments, gameplay area 502 may not include a dedicated camera control, such as camera control 503, though still permit the user to change the current view. Further, a user may interact with gameplay area 502 in any suitable manner, including via the input methods described above, in order to change the current view.

Interface 500 may additionally include a number of content windows for providing users of interface 500 with information relevant to the currently selected sporting event. As shown in FIG. 5., the content windows include team information indicators 504 and sporting event score for 506. However, in other embodiments, interface 500 may exclude one or more of the above listed content windows, and information normally presented in the excluded content windows may be included in other content windows, and/or not shown in interface 500. Furthermore, interface 500 may include one or more additional content windows.

Team information indicators 504 provide users with information pertaining to the teams playing in the currently selected sporting event. In FIG. 5, the team information indicators 504 provide each team's name, as well as each team's current win/loss record. However, other types of information may additionally be shown in team information indicators 504, including the number of points each team has scored, the number of timeouts each team has remaining, the number of penalties or fouls committed by each team, information regarding the team's play schedule, the name of each team's home city, whether the team is at home or visiting, as well as virtually any other relevant information.

Sporting event score indicator 506 includes information regarding the current score and/or team standings for the sporting event. In some embodiments, sporting event score indicator 506 may provide additional information related to the relative performances of each team. For example, sporting event score indicator 506 may indicate the number of timeouts remaining for each team, the number of penalties and/or fouls committed by each team, the total number of yards covered by each team, a sporting event clock, each team's current win/loss ratio, as well as any other relevant information. Additionally, the content of sporting event score indicator 506 depends upon the currently selected sporting event. For example, when a selected sporting event is a baseball game, sporting event score indicator 506 may include runs, hits, and errors for each team, among other potential baseball specific information which may be displayed.

Further, sporting event content windows, including team information indicators 504 and sporting event score indicator 506, may be selected or otherwise interacted with by one or more users in order to change the information presented. For example, a user may be able to select a window in order to alter the information displayed in the content window. As a result of interaction the content window may present alternate and/or more detailed information, and/or may direct the user to a new window/screen/application where additional information may be obtained.

Interface 500 may dynamically update as additional client-readable data packages are received and/or loaded. As such, information presented in playback area 502, as well as the information content windows, may dynamically change as events in the selected sporting event take place. For example, the players represented in playback area 502, as well as each player's respective position, may change substantially in real-time, allowing a user to see a virtual representation of the selected sporting event as the sporting event takes place, or as the sporting event took place in the past. Playback area 502 may dynamically render one or more virtual arrows, lines, or other movement indicators in order to show movement of individual players, as well as any game balls or other relevant objects. Representation of players in gameplay area 502 may move substantially simultaneously to their real-world counterparts according to updated player-position data, allowing a user to view a sporting event as it happens from any desired angle/viewpoint. Further, information presented in team information indicators 504 and sporting event score indicator 506 may change substantially in real-time as updated auxiliary information and/or supplemental information is received from one or more network-accessible computers/supplemental content sources.

Interface 500 additionally includes a sporting event feed 508. Sporting event feed 508 may include audio/video content fir the currently selected sporting event. In the event where the selected sporting event is a live sporting event, or a sporting event which is currently being played, sporting event feed 508 may comprise a live video showing events in the sporting event as they take place. Further, if the selected sporting event is a sporting event which has already finished, or a user chooses to view a part of a live sporting event which has already occurred, sporting event feed 508 may comprise recorded and/or archived footage of the selected sporting event at a user-selected point in time. Live and/or recorded game footage may be received from a supple mental content source, such as supplemental content source 214B shown in FIG. 2. Sporting event feed 508 may be selected or otherwise interacted with via one or more of the methods described above in order to change the display of the video content. For example, selecting sporting event feed 508 may change the size of the displayed video such that it uses the entire display, thereby replacing interface 500. In such an example, additional interactions may then be possible in order to restore interface 500, or display interface 500 on another display and/or hardware device. In other examples, interacting with sporting event feed 508 may remove sporting event feed 508 from interface 500 and/or display sporting event video content on another display and/or hardware device (e.g., auxiliary computing device 118 from FIG. 1).

Also shown in FIG. 5 is sporting event timeline 510. Timeline 510 includes a time indicator 511, a time axis 512, time period dividers 513, and playback controls 514. During gameplay, time indicator 511 may progress along time axis 512, indicating the passage of tune. Time period dividers 513 demarcate discrete periods, quarters, or other specified windows of time within the sporting event. For example, in a football game, time period dividers indicate divisions between game quarters. Playback controls 514 may be selected or otherwise interacted with by a user in order to affect the manner in which sporting event playback is presented. For example, interacting with playback control 514 may pause sporting event playback, allowing the user to, for example, take a break, and/or review information presented by interface 500. Additionally, a user may interact with time indicator 511 in order to change the current playback position of the sporting event. For example, a user may move time indicator 511 across time axis 512, in order to review game events which have already taken place. Additionally, the user may be able to skip ahead and view game events which took place more recently than the events which the user had previously been viewing.

Altering the current sporting event playback position may affect some or all information presented by interface 500. For example, the identities and/or positions of the players represented in gameplay area 502 may change according to the new playback position, in order to reflect player-position data and auxiliary information received for the user-designated time frame. Other information, including information presented by team information indicators 504 and sporting event score indicator 506, as well as other content windows, may also change in order to reflect the status of such information at the user selected time. For example, if a user chooses to move a sporting event playback position back to the start of the sporting event,the score indicated by sporting event score indicator 506 may change to show that each team had zero points at the sporting event's start.

Furthermore, audio and video content shown in sporting event feed 508 may also change as the user changes the sporting event's playback position. For example, if the user chooses to move the sporting event playback position back to the start of the sporting event, video content presented by sporting event feed 508 may change to show recorded and/or archived video footage of the events which took place at the start of the sporting event. In other embodiments, content shown in sporting event feed 508 may not be affected when the user changes the sporting event playback position. In this manner, a user may be able to review events which took place at other times during gameplay via gameplay area 502, while still being able to view live gameplay events in sporting event feed 508 as they occur.

In some embodiments, interface 500 additionally includes information selection bar 516, which allows a user to select from among a plurality of potential information sets for display. As shown in FIG. 5, information selection bar 516 shows a plurality of potential sporting events for selection by the user. Some of these sporting events may be live, while others have already finished, and still others have yet to start. Additional information pertaining to the status of each available sporting event may be shown in order to help the user decide which sporting event to select. For example, part of information selection bar 516 describes a live sporting event between Team C and Team D, and includes information relating to the sporting event's current score and sporting event clock status. A user may be able to select this sporting event for presentation by interface 500, and the information presented by the various elements of interface 500 will change according to the new selected sporting event. For example, face 500 may render data from a different received client-readable data package, and/or request that different client-readable data packages be sent by the network-accessible computer. However, in some embodiments, the audio and/or video content displayed in sporting event feed 508 may not be affected when a user selects a new sporting event for presentation. This may allow a user to review events which have taken place in other sporting events of interest, while still viewing events which take place in the user's currently-selected sporting event. Additionally, in some embodiments, when particularly important, interesting, and/or otherwise noteworthy events occur or are expected to occur in one of the sporting events shown in information selection bar 516, interface 500 may notify the user, or otherwise draw the user's attention to the indicated event. Interface 500 optionally may automatically switch to such sporting events when operating in a highlight mode of operation.

While FIG. 5 shows information selection bar 516 as displaying other potential sporting events for selection by the user, virtually any information may be displayed for selection according to the content of the information displayed in interface 500. For example, in some embodiments, a user may use interface 500 to review his or her fantasy sports team. Information selection bar 516 may then allow a user to select and review alternate fantasy teams, fantasy teams from other sports, friends' fantasy teams, and/or any other relevant information. For example, information selection bar 516 may include a listing of fantasy players, and selecting a fantasy player will bring up a listing of plays in which the fantasy player scored fantasy points, thus allowing a user to easily switch between such plays. In other examples, a user may review drives/plays which have taken place in a football game via a drive chart, and an information selection bar 516 may allow the user to switch between the drives/plays available for display.

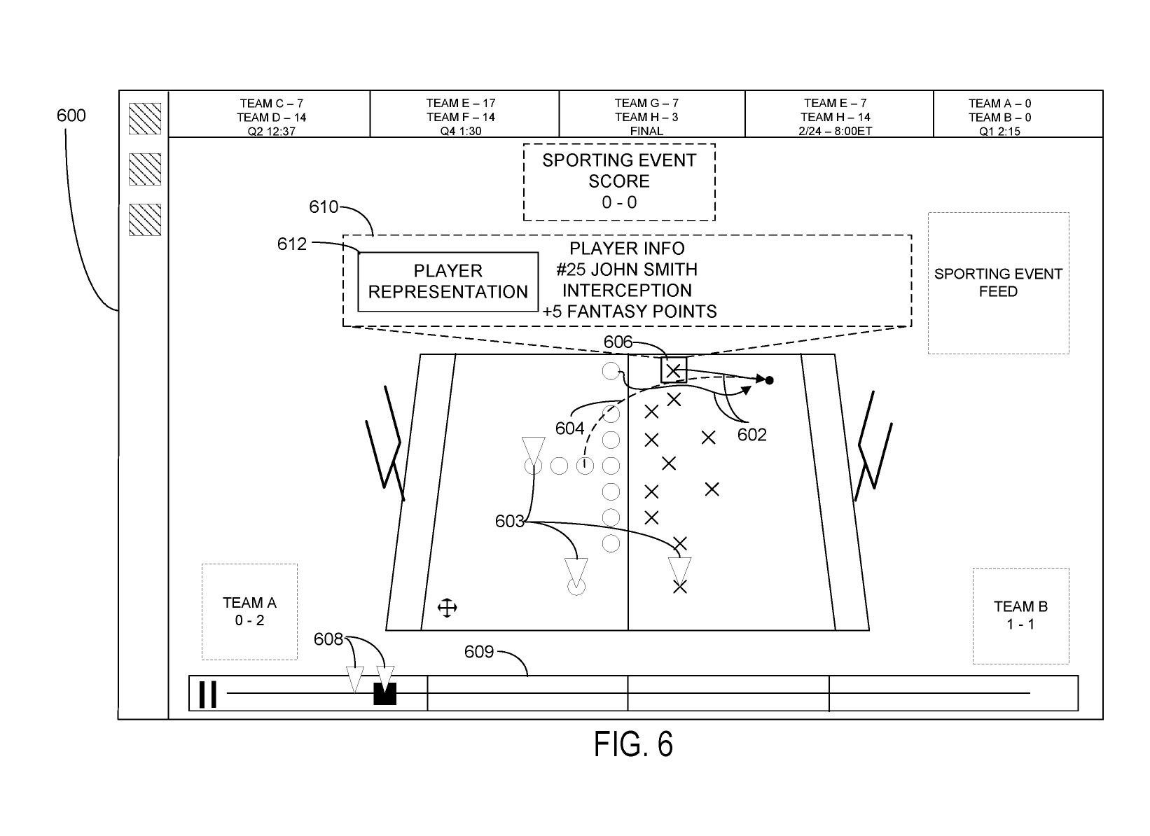

Interface 500 additionally shows selected sporting event information window 518. During interaction with interface 500, a user may select one or more interface elements, and additional and/or specific information relating to those elements may be shown in selected sporting event information window 518. Examples of information which may be displayed in window 518 is prodded below with respect to FIG. 6.

Futhermore, interface 500 includes navigation bar 520, which may include a plurality of navigation icons 522. A user may interact with navigation bar 520, as well as navigation icons 522, in order to change the content displayed in interface 500. For example, selecting one of the navigation icons 522 may direct the user to a fantasy sports screen, replacing the information presented by interface 500 with information pertaining to the user's fantasy sports teams, as well as other relevant fantasy sports information. Another of the navigation icons 522, when selected, may direct the user to a sporting event schedule screen, a team standings screen, a player ranking screen, etc. Additionally, interaction with the navigation icons 522 may result in new screens appearing within the user's currently active application such as, for example, menu/settings screens, and/or may direct the user to an alternate application configured to present the user's desired information.

Interface 500 may be modified to utilize virtually any configurations/combinations of information in order to present information to a user. The specific elements described above, including the gameplay area 502, the team information indicators 504, the sporting event status indicator 506, the sporting event feed 508, the timeline 510, the information selection bar 516, the selected sporting event information window 518, and the app navigation bar 520 may be modified in virtually any way, or excluded altogether. Additionally, other elements and/or content windows may be added to or otherwise incorporated within interface 500 in order to more effectively present sporting event information.

Turning now to FIG. 6, a virtual interactive interface 600 is shown in which the selected sporting event is a football game. As with interface 500, interface 600 includes representations of a number of players participating in a sporting event. Further, selection of a representation of a player causes interface 600 to display information relevant to the selected player. As shown in FIG. 6, an important play has just occurred, and a user has selected a particular player representation in order to obtain additional information regarding the player. This may include any combination of player-position data, auxiliary information, and supplemental information. Movement arrows 602 indicate movements made by key players in the recently completed play, and ball path for 604 shows the path taken by the game ball in the recently completed play. In this specific example, the thrown bail was intercepted by a defending player 606, and a user has selected the defending player's representation 606 in order to view additional information specific to that player. Player and ball movement may be represented in any suitable manner.

A user interface, such as interface 600, may represent on or more notable players as described above differently from other players participating in the sporting event. These notable players may include the Afterburner, Workhorse, Catalyst, etc. In some embodiments, face 600 may determine a “hotness” rating for each player on the field depending upon their current positional data, their game stats, and/or their performance in similar historical situations, as well as any other relevant metrics, and highlight players whose inferred “hotness” exceeds a certain threshold as being notable players. Three notable players 603 are indicated in FIG. 6. In some embodiments, a user may select one of the indicated player representations 603 in order to review information specific to that particular player, including, for example their current speed, numerical hotness value, and/or likelihood of being targeted or otherwise playing an important role in an upcoming play. Notable players may be represented in any suitable fashion. Though inverted triangles are shown in FIG. 6, alternate implementations may highlight notable players in other ways.

Furthermore, an important event indicator 608 has been added to the timeline 609 in order to indicate that an important otherwise notable event occurred at that specific moment in time. As shown, timeline 609 currently includes two important event indicators 608, which may be selectable by a user in order to review additional information pertaining to each important event. For example, selecting an important event indicator 608 may generate a new content window including information relevant to the event, and/or present a video replay of the event. Furthermore, a user may select an important event indicator in order to move the sporting event's playback position to the moment at which the important event occurred, in order to review the important event via a virtual gameplay area.

Information for selected player 606 is presented in selected sporting event information window 610. As shown, window 610 includes information regarding the selected player, including the player's name and number, as well as information regarding the player's role in the most recent play, and the corresponding change in the player's fantasy point value. However, any suitable information regarding the selected player may be displayed. For example, the player's height/weight, current game stats, season stats, contract information, previous team affiliations, hometown, etc. may be displayed by selected information window 610. Furthermore, selected sporting event information window 610 includes a representation 612 of the selected player. Representation 612 may take any suitable form, including but not limited to an image of the player's face, helmet, number, torso, virtual avatar, initials, among other potential representations. The player information presented may be acquired through one or more content sources.

Selected sporting event information windows similar to window 610 may provide information regarding virtually any user selected element of interface 610. For example, a user may select any individual player representation, and window 610 may display virtually any information pertaining the selected player. For example, selecting a particular player representation may provide that player's statistics for the current sporting event and/or the entire season, fantasy information for the player (the player's owner and current fantasy point value), as well as a player's inferred “hotness” rating and a predicted likelihood that the selected player will be targeted in an upcoming play. In other embodiments, a user may select a team name, a team score, a gameplay landmark, an important event, indicator, or other selectable interface elements in order to view detailed information for the selected element in window 610.

Information about specific players may be displayed in selected sporting event information window 610 even when a user has not selected any particular players. For example, window 610 may automatically display sporting event summaries, information pertaining to specific players, teams, owners, and/or coaches, and/or play predictions, notable players, as well as any other potentially relevant information. Window 610 may cycle through such information randomly, and/or in a predetermined order, and/or according to an inferred importance/relevance of the information.

In some embodiments, a variety of social features may be included within interface 600. For example, interface 600 may include one or more mini games, and/or other user engagement features. Such a mini game may ask users to predict play outcomes before the plays begin. For example, the mini game may ask a user to predict whether the offensive team will attempt to pass the ball or run the ball, whether the play will result in a first down, the number of yards gained/lost, whether the play will result in a touchdown, and/or whether the quarterback will be sacked, as well as other potential user-predictable results. Furthermore, the mini game may ask a user to indicate on a display where the user believes the next line of scrimmage will be. In some embodiments, interface 600 may evaluate the accuracy of each user's predictions, and display the result of this evaluation at the end of each play. Users may compete against each other, with each user attempting to provide the best possible predictions. Interface 600 may display the overall accuracy each user's predictions over the course of a sporting event/season. Such information may be used to rank a given user against other users in his family/friend group, as well as other users nationally/globally, in order to generate user viewable leaderboards. Furthermore, players may be given virtual awards/unlock virtual achievements for making consistently accurate predictions.

Interface 600 may further include functionality for allowing a user to communicate with other users and/or interact with social networking/messaging services. For example, interface 600 may provide live text, voice, and/or video communication functionality, allowing a user to communicate with other users who may be viewing the same selected sporting event and/or competing against the user in one or more mini games/fantasy leagues. Additionally, interface 600 may allow users to share information to one or more social networking/messaging services. For example, interface 600 may award a user one or more awards/achievements as the user participates in mini games, and the user may notify his peers/social group of these awards/achievements as they are awarded. Furthermore, a user may compose messages/posts regarding the user's thoughts/opinions regarding the progress of one or more sporting events, the status of one or more players/teams, the status of a user's fantasy team/player, the results of one or more plays/sporting events, as well as any other posts/messages the user may wish to generate. These posts may be submitted to any number of social networking/messaging services specified by the user. Such posts/messages may be manually composed by a user, and/or automatically composed by interface 600 responsive to a variety of events. Interface 600 may also include one or more social feeds, allowing a user to see messages/posts generated by other users.

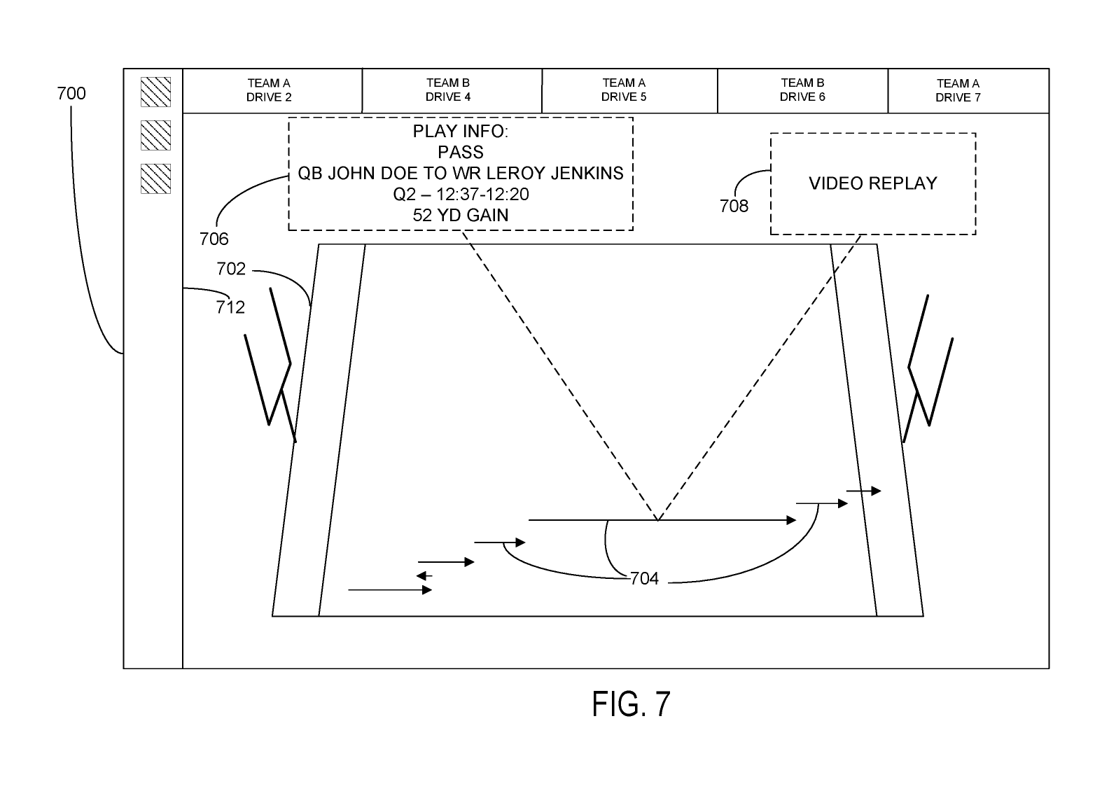

A user interface as described above may also be usable to represent movements of a game ball during a series of periods of gameplay activity. In the example of air American football game, this may take the form of a drive chart. FIG. 7 shows a user interface, interface 700, including an interactive drive chart 702. Drive chart 702 allows a user to view all of the plays which have occurred in a selected drive in a football game. Plays in drive chart 702 are represented by play indicators 704, where the length of each arrow indicates the magnitude of the play's yardage change, and the direction of each arrow indicates the direction of the yardage change. In some examples, indicators other than arrows may be used to indicate plays which have occurred. For example, lines, arcs, dashes, and/or any other suitable indicators, may be utilized. Further play indicators such as indicators 704 may be color coded, and/or otherwise labelled in order to identify plays determined to have been particularly beneficial/detrimental to the driving team, players involved in the play,and/or other information.

In some embodiments, a user may select a particular play indicator 704 in order to review detailed information pertaining to the particular play. In FIG. 7, a user has selected a particular play, and information pertaining to the selected play is included in play information window 706. Specifically, play information window 706 shows the type of play (e.g., pass, run, etc.), the players involved in the play, the time which the play occurred, and the yardage change resulting from the play. Virtually any relevant information may be presented by play information window 706, and in other examples, windows similar to window 706 may include different information from that which is explicitly described herein.

Further, selection of a specific play indicator 704 may generate a video replay window 708. Replay window 708 may present recorded/archived audio/video footage of the selected play, allowing a user to view the selected play as it occurred. In some embodiments, after selecting a particular play, a user may view the play in a gameplay area similar to gameplay area 502/602, allowing the user to see the positions and movements of individual players, from any angle/viewpoint, as the play occurred.

In some embodiments, the methods and processes described herein may be tied to a computing system of one or more computing devices. In particular, such methods and processes be implemented as a computer-application program or service, an application-programming interface (API), a library, and/or other computer-program product.

FIG. 8 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices. Computing system 800 may take the form of a network-accessible computer, such as network-accessible computer 210 described above.

Computing system 800 includes a logic machine 802 and a storage machine 804. Computing system 800 may optionally include a display subsystem 806, input subsystem 808, network-communications interface 810, and/or other components not shown in FIG. 8.

Logic machine 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing; devices configured in a cloud-computing configuration.

Storage machine 804 includes one or more physical devices configured to hold instructions executable by the logic machine to implement the methods and processes described herein. When such methods and processes are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices.

It will be appreciated that storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 802 and storage machine 804 may be integrated together into one or more hardware-logic components. Such hardware-logic components may include, field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 implemented to perform a particular function. In some cases, a module, program, or engine may be instantiated via logic machine 802 executing instructions held by storage machine 804. It will be understood that different modules, programs, and/or engines may be instantiated from the same application, service, code block, object, library, routine, API, function, etc. Likewise, the same module, program, and/or engine be instantiated by different applications, services, code blocks, objects, routines APIs, functions, etc. The terms “module,”“program, ” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 806 nay be used to present a visual representation of data held by storage machine 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic machine 802 and/or storage machine 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, network-communications interface 810 may be configured to communicatively couple computing system 800 with one or more other computing devices via a computing network. Network-communications interface 810 may include wired and/or wireless communication devices compatible with one or more different communication protocols. As non-limiting examples, the network-communications interface 810 configured for communication via a wireless telephone network, or a wired or wireless local- or wide-area network. In some embodiments, the network-communications interface may allow computing system 800 to send and/or receive messages to and/or from other devices via a network such as the Internet.

In an example, a network-accessible computer comprises: a network-communications interface configured to receive player-position data via a computer network, the player-position data indicating a multi-dimensional position for each of a plurality of players participating in a sporting event; and a logic machine configured to: derive auxiliary information from at least the player-position data, the auxiliary information not included in the player-position data and indicating specific attributes for one or more of the plurality of players during a period of game activity in the sporting event; package the auxiliary information with the player-position data into a client-readable data package usable by a client computing device to construct a user interface visualizing at least the player-position data and auxiliary information; and send the client-readable data package to the client computing device via the network-communications interface. In this example or any other example, the logic machine is further configured to verify the player-position data at least in part by determining that the player-position data is received for an expected number of players. In this example or any other example, the auxiliary information indicates which of the plurality of players had possession of a game ball during the period of game activity. In this example or any other example, the auxiliary information indicates an initial position and a final position of the game ball relative to at least one dimension during the period of game activity. In this example or any other example, the auxiliary information includes a top speed for one or more players. In this example or any other example, the auxiliary information identifies one or more notable players having a highest ranking with respect to one or more attributes, and the user interface represents the one or more notable players differently from one or more other players. In this example or any other example, the player-position data is received as a stream of data packets, each data packet corresponding to one or more different time frames of game activity. In this example or any other example, the network-communications interface is further configured to receive supplemental information pertaining to the sporting event, and the logic machine is further configured to derive the auxiliary information based at least in part on the supplemental information and package the supplemental information in the client-readable data package for visualization by the client computing device. In this example or any other example, the user interface includes representations of one or more of the plurality of players, and selection of a representation of a player causes the user interface to display information relevant to the player. In this example or any other example, the user interface represents movements of a game ball. In this example or any other example, the client-readable data package is sent to the client computing device for near real-time visualization of at least the player-position data and auxiliary information.

In an example, a method for presenting sporting event information comprises: receiving player-position data indicating a multi-dimensional position for each of a plurality of players participating in a sporting event; deriving auxiliary information from at least the player-position data, the auxiliary information indicating specific attributes for one or more of the plurality of players during a period of game activity in the sporting event; packaging the auxiliary information with the player-position data into a client-readable data package usable by a client computing device to construct a user interface visualizing at least the player-position data and auxiliary information; and sending the client-readable data package to the client computing device. In this example or any other example, the auxiliary information indicates which of the plurality of players had possession of a game ball during the period of game activity. In this example or any other example, the auxiliary information indicates an initial position and a final position of the game ball relative to at least one dimension during the period of game activity. In this example or any other example, the auxiliary information includes a top speed for one or more players. In this example or any other example, the player-position data is received as a stream of data packets, each data packet corresponding to one or more different time frames of game activity. In this example or any other example, the client-readable data package is sent to the client computing device for near real-time visualization of at least the player-position data and auxiliary information.

In an example, a network-accessible computer comprises: a network-communications interface configured to receive player-position data via a computer network, the player-position data indicating multi-dimensional position for each of a plurality of players participating in a football game; and a logic machine configured to: derive auxiliary information from at least the player-position data, the auxiliary information not included in the player-position data and indicating specific attributes for one or more of the plurality of players during a play in the football game including an indication of which of the plurality of players possess a football; package the auxiliary information with the player-position data into a client-readable data package usable by a client computing device to construct a user interface visualizing at least the player-position data and auxiliary information; and send the client-readable data package to the client computing device via the network-communications interface. In this example or any other example, the auxiliary information includes a top speed for one or more players. In this example or any other example, the client-readable data package is sent to the client computing device for near real-time visualization of at least the player-position data and auxiliary information.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A network-accessible computer, comprising:
a network-communications interface configured to receive player-position data via a computer network, the player-position data indicating a multi-dimensional position for each of a plurality of players participating in a sporting event; and
a logic machine configured to:
derive auxiliary information from at least the player-position data, the auxiliary information not included in the player-position data and indicating specific attributes for one or more of the plurality of players during a period of game activity in the sporting event;
package the auxiliary information with the player-position data into a client-readable data package usable by a client computing device to construct a user interface visualizing at least the player-position data and auxiliary information; and
send the client-readable data package to the client computing device via the network-communications interface.

2. The network-accessible computer of claim 1, where the logic machine is further configured to verify the player-position data at least in part by determining that the player-position data is received for an expected number of players.

3. The network-accessible computer of claim 1, where the auxiliary information indicates which of the plurality of players had possession of a game ball during the period of game activity.

4. The network-accessible computer of claim 3, where the auxiliary information indicates an initial position and a final position of the game ball relative to at least one dimension during the period of game activity.

5. The network-accessible computer of claim 1, where the auxiliary information includes a top speed for one or more players.

6. The network-accessible computer of claim 1, where the auxiliary information identifies one or more notable players having a highest ranking with respect to one or more attributes, and the user interface represents the one or more notable players differently from one or more other players.

7. The network-accessible computer of claim 1, where the player-position data is received as a stream of data packets, each data packet corresponding to one or more different time frames of game activity.

8. The network-accessible computer of claim 1, where the network-communications interface is further configured to receive supplemental information pertaining to the sporting event, and where the logic machine is further configured to derive the auxiliary information based at least in part on the supplemental information and package the supplemental information in the client-readable data package for visualization by the client computing device.

9. The network-accessible computer of claim 8, where the user interface includes representations of one or more of the plurality of players, and selection of a representation of a player causes the user interface to display information relevant to the player.

10. The network-accessible computer of claim 1, where the user interface represents movements of a game ball.

11. The network-accessible computer of claim 1, where the client-readable data package is sent to the client computing device for near real-time visualization of at least the player-position data and auxiliary information.

12. A method for presenting sporting event information, the method comprising:
receiving player-position data indicating a multi-dimensional position for each of a plurality of players participating in a sporting event;
deriving auxiliary information from at least the player-position data, the auxiliary information indicating specific attributes for one or more of the plurality of players during a period of game activity in the sporting event;
packaging the auxiliary information with the player-position data into a client-readable data package usable by a client computing device to construct a user interface visualizing at least the player-position data and auxiliary information; and
sending the client-readable data package to the client computing device.

13. The method of claim 12, here the auxiliary information indicates which of the plurality of players had possession of a game ball during the period of game activity.

14. The method of claim 13, the auxiliary information indicates an initial position and a final position of the gameball relative to at least one dimension during the period of game activity.

15. The method of claim 12, where the auxiliary information includes a top speed for one or more players.

16. The method of claim 12, where the player-position data is received as a stream of data packets, each data packet corresponding to one or more different time frames of game activity.

17. The method of claim 12, where the client-readable data package is sent to the client computing device for near real-time visualization of at least the player-position data and auxiliary information.

18. A network-accessible computer, comprising:
a network-communications interface configured to receive player-position data via a computer network, the player-position data indicating a multi-dimensional position for each of a plurality of players participating in a football game; and
a logic machine, configured to:
derive auxiliary information from at least the player-position data, the auxiliary information not included in the player-position data and indicating specific attributes for one or more of the plurality of players during a play in the football game including an indication of which of the plurality of players possess a football;
package the auxiliary information with the player-position data into a client-readable data package usable by a client computing device to construct a user interface visualizing at least the player-position data and auxiliary formation; and
send the client-readable data package to the client computing device via the network-communications interface.

19. The network-accessible computer of claim 18, where the auxiliary information includes a top speed for one or more players.

20. The network accessible computer of claim 18, where the client-readable data package is sent to the client computing device for near real-time visualization of at least the player-position data and auxiliary information.
